(19) United States
(12) Patent Application Publication
(10) Pub. No.: US 2002/0179797 A1
(43) Pub. Date: Dec. 5, 2002

(54) Device for fitting a load-bearing bracket to an upright support

(76) Inventor: Pedro Cunha, Hestra (SE)

Correspondence Address: SUGHRUE MION, PLLC, 2100 PENNSYLVANIA AVENUE, N.W., WASHINGTON, DC, 20037, US

(21) Appl. No.: 10/148,834

(22) PCT Filed: Dec. 8, 2000
(86) PCT No.: PCT/SE00/02472

(30) Foreign Application Priority Data
Dec. 13, 1999 (SE) 9904545-2
Aug. 24, 2000 (SE) 0003001-5

(51) Int. Cl. E04G 3/08; E06B 7/28

(52) U.S. Cl. 248/343; 248/235; 248/250

(57) ABSTRACT

Device for fitting a load-bearing bracket for a shelf or the like, for example, to an upright support. At its end facing the upright support (2) the bracket (1) is designed with two vertically separated engaging members (6, 7) and the upright has at least one vertical row of spaced fitting apertures (18). The device comprises an adapter (8) and a fitting member (15) for fitting the adapter to the upright support (2). Two opposite sides of the adapter (8) each have a vertical row of spaced fitting apertures (12), the apertures on one side of the adapter having an interval that is equal to the distance between engaging members (6, 7) of the bracket (1). The fitting member (15) is designed with two opposing pairs of vertically separated engaging members (13, 14; 16, 17), the distance between the engaging members (13, 14) in one pair being equal to the interval between the fitting apertures (12) on the other side of the adapter (8), whilst the distance between the engaging members (16, 17) in the other pair is equal to the interval between the fitting apertures (18) in the upright support (2).

### TECHNICAL FIELD

The present invention relates to a device for fitting a load-bearing bracket for a shelf or the like, for example, to an upright support provided with at least one vertical row of spaced fitting apertures.

### BACKGROUND TO THE INVENTION

Brackets of this type are generally used in pairs with an intervening shelf plane in order to form a shelf that can easily be fitted to two upright supports.

Since there is no standard laid down governing the interval between the holes in upright supports or the distance between the engaging members of the bracket, there are a number of different makes of upright supports and brackets currently on the market, which cannot be used together.

The interval between the fitting apertures in the upright is furthermore relatively large, which means that the shelves cannot be finely adjusted for height. In many instances this means that optimum use cannot be made of valuable space for goods in a shop, for example.

### OBJECT OF THE INVENTION

An object of the present invention is to produce a device, which enables a bracket of a particular make to be fitted to an upright support of another make without the need for the entire bracket to be specially manufactured in order to fit precisely the upright support in question.

Another object is to produce a device for fitting load-bearing brackets to upright supports, which will permit a greater degree of fine height adjustment than that corresponding to the interval between the fitting holes in the upright support.

The invention is based on the insight that the aforementioned objects can be achieved by means of an adapter and a fitting member, of which only the fitting member needs to be adjusted depending on the upright support in question.

The special characteristic of a device of the type specified in the introductory part is that the end of the bracket facing the upright support is provided with an adapter, that the device comprises a fitting member for fitting the adapter to the upright support, that the said fitting member is designed with opposing pairs of engaging members separated in the vertical direction, that the edge surface of the adapter facing the upright support has a vertical row of spaced fitting apertures, that the interval between pairs of the said apertures is equal to the distance between the one pair of engaging members on the said fitting member, and that the distance between the second pair of engaging members on the said fitting member is equal to the interval between pairs of fitting apertures in the upright support.

This device allows a shelf manufacturer to use the same bracket for fitting a shelf to different upright supports by using a single fitting member adapted to the upright in question.

By utilising a relatively fine interval between the fitting apertures in the edge surface of the adapter, the distance between two shelf planes situated one above the other can be finely adjusted essentially to the precise distance required in each case.

Other characteristics of the invention will be apparent from the following claims.

The invention will be described in more detail below with reference to the embodiments shown by way of example in the drawings attached.

### BRIEF DESCRIPTION OF THE FIGURES

FIG. 1 shows the constituent parts of one embodiment of a device according to the invention.

FIG. 2 illustrates how a bracket is fitted to an upright support when using a device according to FIG. 1

FIG. 3 illustrates how a device according to FIG. 1 is fitted to a bracket.

FIG. 4 shows a second embodiment of a device according to the invention.

### DETAILED DESCRIPTION OF PREFERRED EMBODIMENTS

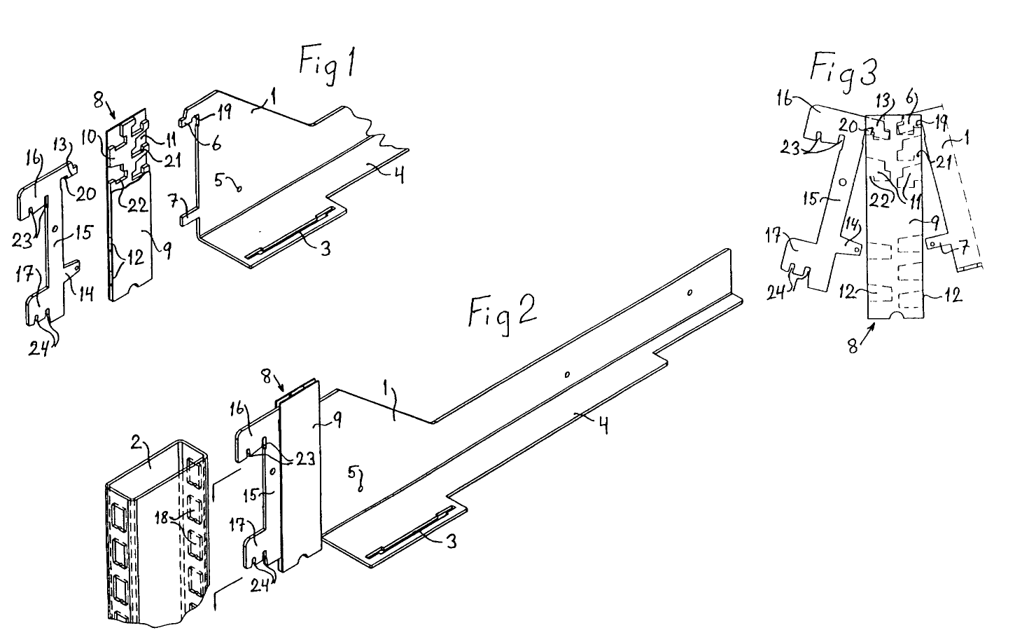

In FIGS. 1 and 2, 1 denotes the end of a load-bearing bracket facing an upright support 2. The bracket shown is intended to be connected to a similar bracket running parallel in order to support a shelf. The brackets are connected by means of a transverse plate (not shown), the ends of which are brought down into a slot 3 in a flange 4 running along each bracket. The flange 4 may then serve as bearing surface for a shelf plane. Alternatively a shelf plane formed from bars can be fitted to the brackets by introducing the ends of the said bars in through holes 5 in the brackets. The shelf may be of the type, for example, described in our Swedish patent application No. 9903198-1, which has an extendable shelf plane.

The end section of the bracket 1 is designed with two projecting engaging members 6, 7. The latter are intended to interact with an adapter 8, which is made up of two side plates 9 and an intermediate spacer plate 10. The spacer plate 10 is designed with indentations 11 along two opposite edges, the said indentations together with the side plates 9 forming a vertical row of fitting apertures 12 along two opposite edge surfaces of the adapter 8.

One row of the said apertures is intended to interact with the engaging members 6 and 7 on the bracket 1, whilst the second row of engagement apertures 12 is intended to interact with engaging members 13, 14, which project in one direction from a plate-shaped fitting member 15. Two engaging members 16, 17, which are intended to interact with fitting apertures 18 in an upright support 2, project in the opposite direction, see FIG. 2.

The adapter 8 is provided with a number, suitably at least three pairs, of fitting apertures 12 with spacing interval equal to the distance between the engaging members 6 and 7 of the bracket 1. It likewise contains a number of apertures 12, suitably at least two pairs, with a spacing interval equal to the distance between the engaging members 13 and 14 on the fitting member 15.

At least the upper engaging members 6 and 13 are each made with a notch formation 19 and 20 respectively, which are designed to be capable of interlocking with corresponding notch formations 21 and 22 respectively in indentations in the spacer plate 10 in the adapter 8.

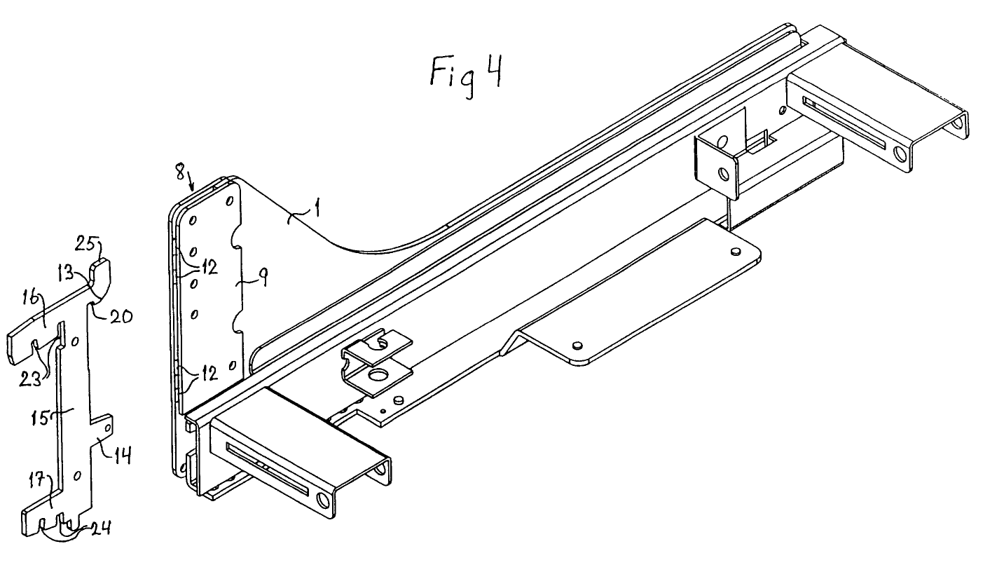

In use, the procedure is as follows. First an adapter 8 is fitted at a suitable height on engaging members 6 and 7 of the bracket 1. This can be done by means of a pivoting movement, as illustrated in FIG. 3. A fitting member 15 is then fitted at a suitable height on the adapter 8, likewise by means of a pivoting movement. The bracket 1 with its adapter 8 and fitting member 15 is then fitted at the desired height to the upright support 1 with the aid of the engaging members 16 and 17, see FIG. 3. In their bottom edges there are indentations 23, 24, which permit a certain angular adjustment in the horizontal plane of the bracket 1. Fitting may, of course, also be done in a different order.

The device described provides great scope for fine adjustment of the height of the bracket, since the fitting member 15 can be fitted both at different heights on the upright 1, and at different heights on the adapter 8. In addition the bracket 1 can also be fitted at different heights on the adapter 8. The height of a shelf can also be easily adjusted later.

FIG. 4 shows a simplified design of a device according to the invention, in which the adapter 8 is fastened to the end of a bracket 1. Alternatively the end of the bracket may be designed in the form of an adapter with fitting apertures 12. In the example shown the bracket is provided with a fitting device for an extendable shelf, which device does not constitute any part of the present invention and will consequently not be described here.

The function in this embodiment of a fitting device according to the invention will be the same as described above, with the exception that the adapter 8 cannot be fitted at different heights on the bracket. On the other hand there is still the facility for fitting the fitting member 15 at different heights on the bracket and also at different heights on the upright support 2. This embodiment, too, which contains a component less than the embodiment according to FIGS. 1-3, thus provides great scope for fine adjustment of the height of a bracket when fitting on a perforated upright support.

In this embodiment one engaging member 13 on the fitting part is designed with an upward-facing notch formation 25 in order to improve the engagement in the adapter 8.

In applying the invention a shelf manufacturer can use a standard bracket for all shelves by providing it with a loose or fixed adapter 8 and a fitting member 15. It is therefore only the distance between the engaging members 16 and 17 of the fitting member 15 that needs to be specially adapted to the respective upright support. Other parts of the device can be manufactured in one design, which means longer production runs and hence lower costs. Use of a device according to the invention also facilitates stockkeeping and fitting.

The invention has been described above in connection with the embodiment shown in the drawing. It can nevertheless by modified in several respects without departing from the scope of the claims, among other things with regard to the design detail of various parts, such as the various engaging members and the adapter, and the number of fitting apertures in the adapter.

1. Device for fitting a load-bearing bracket for a shelf or the like, for example, to an upright support (2) provided with at least one vertical row of spaced fitting apertures (18), characterized in that the end of the bracket (1) facing the upright support (2) is provided with an adapter (8), that the device comprises a fitting member (15) for fitting the adapter to the upright support (2), that the said fitting member (15) is designed with opposing pairs of engaging members (13, 14: 16, 17) separated in the vertical direction, that the edge surface of the adapter (8) facing the upright support (2) has a vertical row of spaced fitting apertures (12), that the interval between pairs of the said apertures is equal to the distance between the one pair of engaging members (13, 14) on the said fitting member (15), and that the distance between the other pair of engaging members (16, 17) on the said fitting member (15) is equal to the interval between pairs of fitting apertures (18) in the upright support (2).

2. Device according to claim 1, characterized in that the adapter (8) is fastened to the bracket (1) and has at least two pairs of fitting apertures (12) for interacting with the engaging members (13, 14) on the fitting member (15)

3. Device according to claim 1 or 2, characterized in that the adapter (8) comprises two essentially rectangular side plates (9) and an intermediate plate-shaped spacer (10) and that the spacer is designed with indentations (11) in one side edge, which together with the side plates (9) form the said fitting apertures (12).

4. Device according to claim 3, characterized in that at least one of the said indentations (11) in each pair of fitting apertures (12) is designed with a notch element (22), which interacts with a corresponding notch element (20) on one of the engaging members (13) of the fitting member (15).

5 Device according to claim 4, characterized in that the upper fitting aperture (12) of each pair of apertures is provided with a notch element (22) on its lower, leading edge.

6. Device according to any of claims 1 to 5, for fitting a load-bearing bracket for a shelf or the like, for example, to an upright support, the bracket (1) at its end facing the upright (2) being designed with two vertically separated engaging members (6, 7) characterized in that it comprises an adapter (8) that can be fitted to bracket (1), that two opposite edge surfaces of the adapter (8) each have a vertical row of spaced fitting apertures (12), that the interval between pairs of apertures in one edge surface of the adapter (8) is equal to the distance between engaging members (6, 7) of the bracket (1), that the interval between pairs of apertures (12) in the other edge surface of the adapter (8) is equal to the distance between the one pair of engaging members (13, 14) on the said fitting member (15), and that the distance between the second pair of engaging members (16, 17) on the said fitting member is equal to the interval between pairs of fitting apertures (18) in the upright support (2).

7. Device according to claim 6, characterized in that the adapter (8) has at least three pairs of fitting apertures (12) for interacting with the engaging members (6, 7) on the bracket (1) and at least two pairs of fitting apertures (12) for interacting with the engaging members (13, 14) on the fitting member (15)

8. Device according to any of claims 1 to 7, characterized in that the engaging members (16, 17) of the fitting member (15), intended for interaction with the fitting apertures (18) in the upright support (2), are designed with indentations (23, 24) in their lower edge surface for accommodating a lower defining wall of each fitting aperture (18).

9 Device according to claim 8, characterized in that each of the said engaging members (16, 17) has at least two indentations (23, 24) in order to permit adjustment of the angle of inclination of the bracket (1).

10. Shelf supported by a bracket along each side, characterized in that each bracket (1) is fitted on an associated upright support (2) by means of a device (8, 15) according to any of claims 1 to 9.
